(19) United States
(12) Patent Application Publication
(10) Pub. No.: US 2014/0223066 A1
(43) Pub. Date: Aug. 7, 2014

(54) Multi-Node Management Mechanism

(71) Applicant: ADVANCED MICRO DEVICES, INC., Sunnyvale, CA (US)

(72) Inventor: Hari Ramachandran, Austin, TX (US)

(73) Assignee: ADVANCED MICRO DEVICES, INC., Sunnyvale, CA (US)

(21) Appl. No.: 13/760,311

(22) Filed: Feb. 6, 2013

(51) Int. Cl. G06F 13/40

(52) U.S. Cl. CPC G06F 13/4004
USPC 710/306

(57) ABSTRACT

The described embodiments include a multi-node management mechanism for managing a plurality of server nodes. These embodiments further comprise a separate set of busses coupled between each of the server nodes and the multi-node management mechanism and a controller in the multi-node management mechanism, the controller being coupled to each bus in the sets of busses. In these embodiments, the controller is configured to handle communications on each bus so that the multi-node management mechanism appears to a corresponding server node to be a separate endpoint for the bus.

### BACKGROUND

1. Field

The described embodiments relate to computing devices. More specifically, the described embodiments relate to a multi-node management mechanism for server nodes.

2. Related Art

Modern server computer systems (“servers”) typically include a baseboard management controller (BMC) that is used for monitoring system information for the server and causing the server to perform actions. The BMC is generally a dedicated microcontroller that communicates with various hardware and software sensors in the server to collect the system information. For example, BMCs collect information such as temperatures, CPU status (power, operating state, errors, temperature, etc.), software/firmware status (basic input/output system (BIOS) errors, operating system status, etc.), etc. The BMC may report the system information to the system administrator (or monitoring system), who can use the information to determine the health, operating state, etc. of the system. In addition, the BMC can cause the server to perform actions such as entering a sleep state, or resetting/power cycling the server (perhaps under the control of a system administrator or a monitoring system).

Although a BMC is useful for monitoring system information and causing the server to perform actions, the BMC is limited to a one-to-one configuration, in which the BMC is used to monitor a single server system (with a single processor, chipset, etc.). As systems progress toward high-density applications with multiple servers connected to a backplane, requiring a BMC to monitor each server system increases the cost and complexity of the system.

### SUMMARY

The described embodiments include a multi-node management mechanism for managing a plurality of server nodes. These embodiments further comprise: (1) a separate set of busses coupled between each of the server nodes and the multi-node management mechanism; and (2) a controller in the multi-node management mechanism, wherein the controller is coupled to each bus in the sets of busses. In these embodiments, the controller is configured to handle communications on each bus so that the multi-node management mechanism appears to a corresponding server node to be a separate endpoint for the bus.

In some embodiments, each set of busses comprises: (1) a general purpose input-output (GPIO) bus; (2) an inter-integrated circuit (I2C) bus and/or system management bus (SMBus); and (3) a low pin count (LPC) bus.

In some embodiments, the multi-node management mechanism comprises at least one processing mechanism in the controller. In these embodiments, the processing mechanism executes, for each set of busses, a separate instance of a driver for each of the GPIO, I2C and/or SMBus, and LPC busses, each driver controlling operations for the corresponding bus in the set of busses.

In some embodiments, the multi-node management mechanism comprises a server node communication mechanism in the controller. In these embodiments, the server node communication mechanism responds to predetermined communications from the server nodes on at least one of the GPIO, 12C and/or SMBus, or LPC busses.

In some embodiments, the multi-node management mechanism comprises a controller memory coupled to the controller. In these embodiments, at least some communications from the server nodes are stored in the controller memory.

In some embodiments, the multi-node management mechanism comprises an external communication mechanism in the controller. In these embodiments, the external communication mechanism forwards selected communications from the controller memory to one or more external devices.

In some embodiments, the multi-node management mechanism comprises a separate input-output port (10 port) coupled to each set of busses between a corresponding node and the controller. In these embodiments, the 10 ports each comprise transmit and receive circuits for communicating between the corresponding node and the controller on the busses in the corresponding set of busses.

In some embodiments, the multi-node management mechanism comprises an Ethernet network interface and the controller is configured to communicate with an external device using the Ethernet network interface.

In some embodiments, the multi-node management mechanism comprises a Universal Asynchronous Receiver/Transmitter (UART), wherein the controller is configured to communicate with an external device using the UART.

### BRIEF DESCRIPTION OF THE FIGURES

FIG. 1 presents a block diagram illustrating a multi-node management mechanism in accordance with some embodiments.

FIG. 2 presents a block diagram illustrating a server in accordance with some embodiments.

FIG. 3 presents a block diagram illustrating a controller in a multi-node management mechanism in accordance with some embodiments.

FIG. 4 presents a block diagram illustrating a set of busses coupled between a server and a multi-node management mechanism in accordance with some embodiments.

FIG. 5 presents a flowchart illustrating a process for handling communications from a server in accordance with some embodiments.

FIG. 6 presents a flowchart illustrating a process for communicating a command or request to a server in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

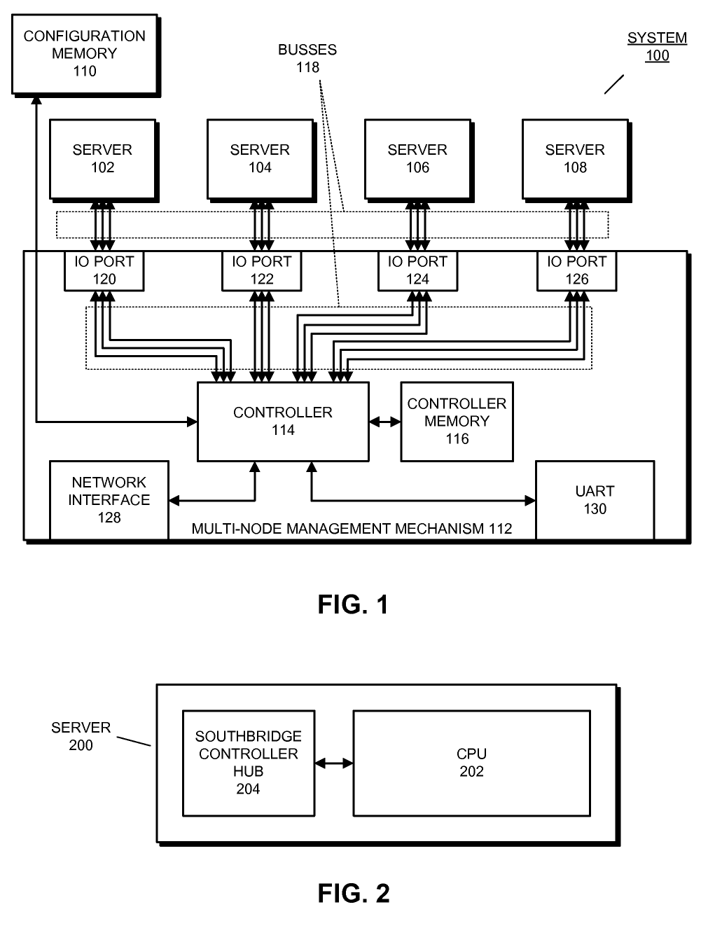

In some embodiments, a computing device (e.g., system 100 (see FIG. 1), servers 102-108, and/or multi-node management mechanism 112) uses code and/or data stored on a computer-readable storage medium to perform some or all of the operations herein described. More specifically, the computing device reads the code and/or data from the computer-readable storage medium and executes the code and/or uses the data when performing the described operations.

A computer-readable storage medium can be any device or medium or combination thereof that stores code and/or data for use by a computing device. For example, the computer-readable storage medium may include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/processor cores/central processing units (CPUs), application-specific integrated circuit (ASIC) chips, field-programmable gate arrays (FPGAs), caches/cache controllers, embedded processors, microcontrollers, graphics processors (GPUs)/graphics processor cores, pipelines, and/or other programmable-logic devices. When such hardware modules are activated, the hardware modules perform some or all of the operations. In some embodiments, the hardware modules include one or more general-purpose circuits that are configured by executing instructions (program code, microcode/firmware, etc.) to perform the operations.

In some embodiments, a data structure representative of some or all of the structures and mechanisms described herein (e.g., system 100, multi-node management mechanism 112, etc. and/or some portion thereof) is stored on a computer-readable storage medium that includes a database or other data structure which can be read by a computing device and used, directly or indirectly, to fabricate hardware comprising the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates/circuit elements from a synthesis library that represent the functionality of the hardware comprising the above-described structures and mechanisms. The netlist may then be placed and routed to produce a data set describing geometric shapes to be applied to masks. The masks may then be used in various semiconductor fabrication steps to produce a semiconductor circuit or circuits corresponding to the above-described structures and mechanisms. Alternatively, the database on the computer accessible storage medium may be the netlist (with or without the synthesis library) or the data set, as desired, or Graphic Data System (GDS) II data.

In the following description, functional blocks may be referred to in describing some embodiments. Generally, functional blocks include one or more interrelated circuits that perform the described operations. In some embodiments, the circuits in a functional block include circuits that execute program code (e.g., machine code, firmware, etc.) to perform the described operations.

### Overview

The described embodiments include a system with multiple server nodes (servers) in a high-density arrangement (e.g., multiple servers that are coupled to a common backplane or that are otherwise associated). The system also includes a multi-node management mechanism that is configured to monitor the servers and/or manage the operation of the servers. In these embodiments, the multi-node management mechanism separately collects and selectively forwards (e.g., to an external device) system information from each of the multiple servers, and communicates with each of the servers to cause the individual server to perform actions such as power cycle, sleep, state reporting, etc.

In some embodiments, a separate set of busses is coupled between each server and the multi-node management mechanism (i.e., the busses coupled to one server are not also coupled to the other servers). Each set of busses generally includes busses for communicating between the corresponding server and the multi-node management mechanism. For example, in some embodiments, the set of busses includes a general purpose input-output (GPIO) bus, an inter-integrated circuit (I2C) bus and/or system management bus (SMBus), and a low pin count (LPC) bus. The busses are used for collecting system information from the multiple servers and for communicating with the servers to cause the individual servers to perform actions.

In some embodiments, the multi-node management mechanism comprises a controller memory. In these embodiments, the controller memory is used both as: (1) a “store-and-forward” memory for system information, and (2) a repository for storing data and instructions used by the controller for performing operations in the multi-node management mechanism. The controller memory is a store-and-forward memory in that communications received from the servers are separately stored within the controller memory. The stored communications may then be retrieved by the controller in the multi-node management mechanism, which determines which, if any, the retrieved information is to be forwarded to an external device.

In some embodiments, the multi-node management mechanism is configured to handle communications on each bus so that the multi-node management mechanism appears to a corresponding node to be a separate endpoint for the bus. In other words, in some embodiments, the multi-node management mechanism behaves in such a way (e.g., responds to communications, sends commands/requests, etc.) that the servers are unaware that they are communicating with and receiving commands/requests from a device (i.e., the multi-node management mechanism) that is coupled to other servers.

By using the multi-node management mechanism to manage multiple servers, the described embodiments enable the collection of information and control of designated actions in the multiple servers without requiring, as in existing systems, a separate BMC for each server. The described embodiments therefore reduce the complexity of the management system for the servers when compared to existing systems, including reducing the number of integrated circuit chips that are required in the computing device, the amount of routing, the amount of power consumed by the management system, etc. In addition, the multi-node management mechanism is configured to communicate with each server, meaning that the server can continue to use existing operating systems, drivers, applications, BIOS, etc.

### Computing Device

FIG. 1 presents a block diagram illustrating a system 100 in accordance with some embodiments. As can be seen in FIG. 1, system 100 includes servers 102-108, configuration memory 110, and multi-node management mechanism 112.

Servers 102-108 (which are interchangeably called “server nodes” or “nodes”) are separate servers that each comprise devices, functional blocks, and circuits for performing computational operations. FIG. 2 presents a block diagram illustrating a server 200 in accordance with some embodiments (any of servers 102-108 may have, but are not required to have, an internal arrangement similar to server 200). As can be seen in FIG. 2, server 200 includes central processing unit (CPU) 202 and Southbridge controller hub 204. CPU 202 comprises one or more integrated circuit chips with one or more computational mechanisms and/or functional blocks (CPUs/processors, processor cores, pipelines, etc.) configured to perform computational operations for server 200.

Southbridge controller hub 204 comprises one or more integrated circuit chips in a logic chipset of server 200 that is/are responsible for handling communication (inputs to and outputs from the server) on relatively slower interfaces such as a general purpose input-output (GPIO) bus, an inter-integrated circuit (I2C) bus and/or system management bus (SMBus), and a low pin count (LPC) bus. In some embodiments, Southbridge controller hub 204 works in combination with a Northbridge controller hub (which is not shown, but which may be coupled between CPU 202 and Southbridge controller hub 204), and the Northbridge controller hub handles communications on relatively faster interfaces such as the interface between memory (not shown) in server 200 and CPU 202.

In some embodiments, server 200 comprises a number of hardware sensors (e.g., temperature sensors, vibration sensors, sound sensors, etc.) and software sensors (e.g., monitoring subroutines in an operating system on server 200, applications/daemons, microcode/firmware applications, BIOS routines, etc.) that are used to collect system information that is to be communicated to multi-node management mechanism 112 using messages/signals on busses 118 (as described herein).

Although server 200 is presented in FIG. 2 using certain subsystems (i.e., CPU 202 and Southbridge controller hub 204), server 200 has been simplified for the purpose of this description. In some embodiments, server 200 comprises additional subsystems, such as memory, power supplies/controllers, fans, mass-storage devices such as disk drives or large semiconductor memories, batteries, media processors, input-output mechanisms and devices, communication mechanisms, networking mechanisms, display mechanisms, etc.

Configuration memory 110 comprises non-volatile memory circuits such as flash memory circuits that are used to store instructions and data for controller 114. For example, in some embodiments, configuration memory 110 includes program code for starting up (booting or bootstrapping) controller 114.

Multi-node management mechanism 112 is a functional block that is configured to separately receive communications from servers 102-108 and determine how the received communications are to be handled, and to communicate commands/requests to servers 102-108 to cause servers 102-108 to perform actions (e.g., enter a sleep state, restart/power cycle, report server system information and/or state, etc.). As can be seen in FIG. 1, multi-node management mechanism 112 comprises controller 114, controller memory 116, busses 118, input-output ports (“IO ports”) 120-126, network interface 128, and UART 130. In some embodiments, multi-node management mechanism 112 is implemented on a single integrated circuit chip.

Controller 114 in multi-node management mechanism 112 a functional block that is configured to perform computational operations for multi-node management mechanism 112. In some embodiments, controller 114 comprises one or more embedded controllers/processors and/or microcontrollers. In some embodiments, controller 114 controls the operation of multi-node management mechanism 112, including handling startup, configuration, and general operation of multi-node management mechanism 112. In addition, in some embodiments, controller 114 performs operations for helping to manage servers 102-108. For example, in some embodiments, controller 114 receives communications from servers 102-108 (which may include retrieving stored communications from controller memory 116, as described below) and determines how the received communications are to be handled. For instance, controller 114 may determine if received communications should be forwarded to an external system such as a monitoring device, a system administrator's computer system, a logging device, etc., if a response should be sent to the server that sent the communication, if the communication indicates that a problem or error encountered by the server should be communicated to a system administrator, etc. As another example, controller 114 may send requests or commands to servers 102-108 to cause a given server to take an action (e.g., power cycling, operating state changing, reporting server system state, etc.).

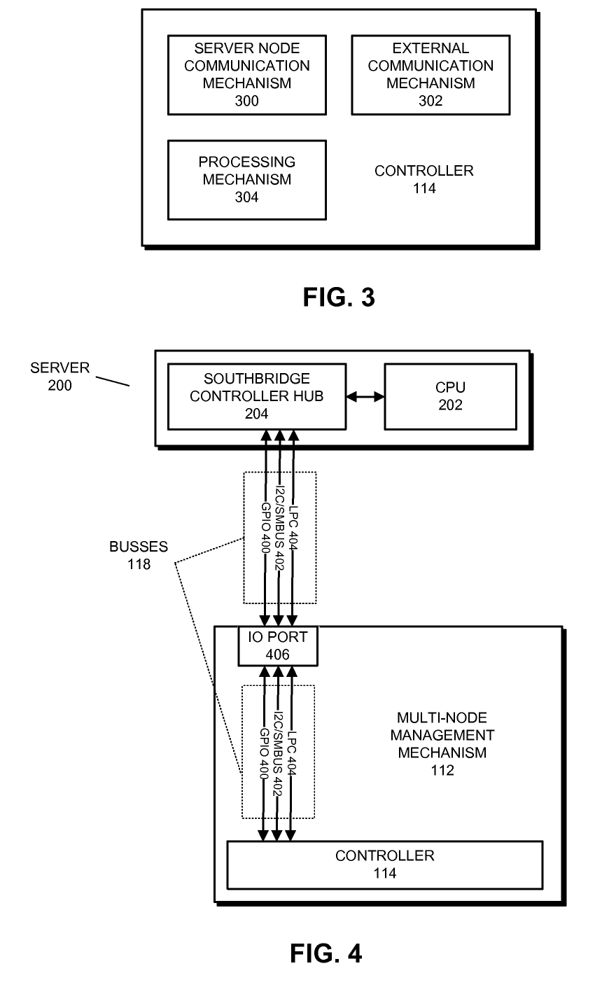

FIG. 3 presents a block diagram illustrating controller 114 in accordance with some embodiments. As shown in FIG. 3, controller 114 includes server node communication mechanism 300, external communication mechanism 302, and processing mechanism 304. Server node communication mechanism 300 is a functional block that responds to predetermined communications from the server nodes on at least one of busses 118. External communication mechanism 302 is a functional block that forwards some communications retrieved from controller memory 116 to one or more external devices. Processing mechanism 304 is a functional block that executes a driver for each bus to each server in controller 114. (Note that the operations performed by some or all of these functional blocks may be attributed generally herein to controller 114 for clarity.)

Controller memory 116 includes memory circuits such as synchronous random access memory (SRAM) that are used for storing communications from servers 102-108 (e.g., log events, server system status reports, error reports, etc.), as well as for storing data and instructions for operating controller 114. In some embodiments, when a communication such as a log event or error report is received from one of servers 102-108, the communication is recorded in controller memory 116. Controller 114 can then retrieve the recorded communication from controller memory 116 and determine if further action should be taken (which is described herein as “store and forward” for the communication). For example, controller 114 can determine if the communication should be communicated to a local external system on UART 130 or if the log event should be communicated to a remote external system on network interface 128.

In some embodiments, controller memory 116 includes a separate area/region of memory (e.g., block of addresses) for each server from servers 102-108. In these embodiments, when a communication is received from a given server (e.g., server 102), some or all of the communication (e.g., the payload of the communication) is stored in the corresponding area in controller memory 116. Thus, in these embodiments, the memory in controller memory 116 is not shared among servers 102-108.

Busses 118 comprise electrical signal lines and interface circuits (e.g., signal line drivers, receivers, encoders/decoders, etc.) that are used to carry communications from servers 102-108 to multi-node management mechanism 112 (and, internally to multi-node management mechanism 112, to controller 114). In some embodiments, busses 118 comprise a set of busses used to receive communications from and communicate commands/requests to servers 102-108. FIG. 4 presents a block diagram illustrating a set of busses 118 coupled between server 200 (which, as described above, may be any one of servers 102-108) and multi-node management mechanism 112 in accordance with some embodiments. As can be seen in FIG. 4, busses 118 comprise the GIPO 400 bus, the I2C and/or SMBus 402, and the LPC 404 bus. In the embodiments shown in FIG. 4, the I2C/SMBus 402 bus is listed as such to illustrate that the bus may be an I2C bus and/or an SMBus bus; thus, these embodiments may use both standards for communicating on the bus or may only use one of the standards.

Note that busses 118 as shown in FIG. 4 represents a copy of the three busses that are separately coupled between each sever 102-108 and multi-node management mechanism 112 (i.e., each set of busses coupled between a server and multi-node management mechanism 112 as shown in FIG. 1 comprises the busses shown in FIG. 4). Thus, between server 102 and controller 114, there is a separate GIPO 400 bus, I2C and/or SMBus 402, and LPC 404 bus, and the same is true between servers 104, 106, and 108 and controller 114.

Generally, busses 118 can be used for transmitting any appropriate communication from the corresponding server to multi-node management mechanism 112 (i.e., any communication that can be formatted in accordance with the underlying standard). For example, in some embodiments, the GPIO 400 bus may be used to communicate commands/requests for controlling the power state of the server and/or resetting the server, communicate timer information (possibly for timers maintained by multi-node management mechanism 112 for the server), communicate interrupts to the server, communicate a presence signal from the server to multi-node management mechanism 112 (or vice versa). As another example, the I2C/SMBus 402 bus may be used to communicate information about the operating status/state/functions of CPU 202 in server 200 (e.g., hardware sensor outputs and/or other physical state values, software sensor outputs and other software state values, etc.). As yet another example, the LPC 404 bus may be used for communicating system events such as errors, operating messages, etc. from server 200 to multi-node management mechanism 112.

In some embodiments, one or more bus in busses 118 comprises multiple individual signal lines. For example, in some embodiments the GPIO 400 bus comprises 12 signal lines, each of which may be assigned for some type of communication between the corresponding server and multi-node management mechanism 112. Generally, there are sufficient signal lines for communicating the described signals and information between servers 102-108 and multi-node management mechanism 112.

IO ports 120-126 comprise circuitry for transmitting and receiving signals from servers 102-108. For example, in some embodiments, IO ports 120-126 comprise transmitters/drivers and receivers, encoders/decoders, memory elements, etc. for each corresponding bus.

Although embodiments are described with a particular arrangement of functional blocks in multi-node management mechanism 112 and in controller 114, some embodiments include a different number and/or arrangement of functional blocks in multi-node management mechanism 112 and/or in controller 114. Generally, the described embodiments can use any arrangement of functional blocks that can perform the operations herein described.

### The Multi-Node Management Mechanism as a Separate Endpoint for Each Server

In the described embodiments, controller 114 (and, more generally, multi-node management mechanism 112) is configured to handle communications on each bus so that the multi-node management mechanism 112 appears to a corresponding node to be a separate endpoint for the bus. For example, in some embodiments, controller 114 includes a separate instance of a driver for each bus connected to controller 114. In these embodiments, as an example, controller 114 includes a driver for each LPC 404 bus between each of servers 102-108 (recall that a separate instance of each bus is coupled between controller 114 and the corresponding server). In this way, communications between a server and the multi-node management mechanism are private/separate from communications between the other servers and the multi-node management mechanism. In addition, controller 114 performs operations (responding to communications, selectively forwarding stored communications, etc.) so that to the corresponding sever, controller 114 appears to be an expected communication partner (e.g., emulates a BMC and other devices for each server). In addition, the multi-node management mechanism is configured to communicate with each server in a manner expected by the server, meaning that the server can continue to use existing operating systems, drivers, applications, BIOS, etc.

### Processes for Managing Multiple Server Nodes

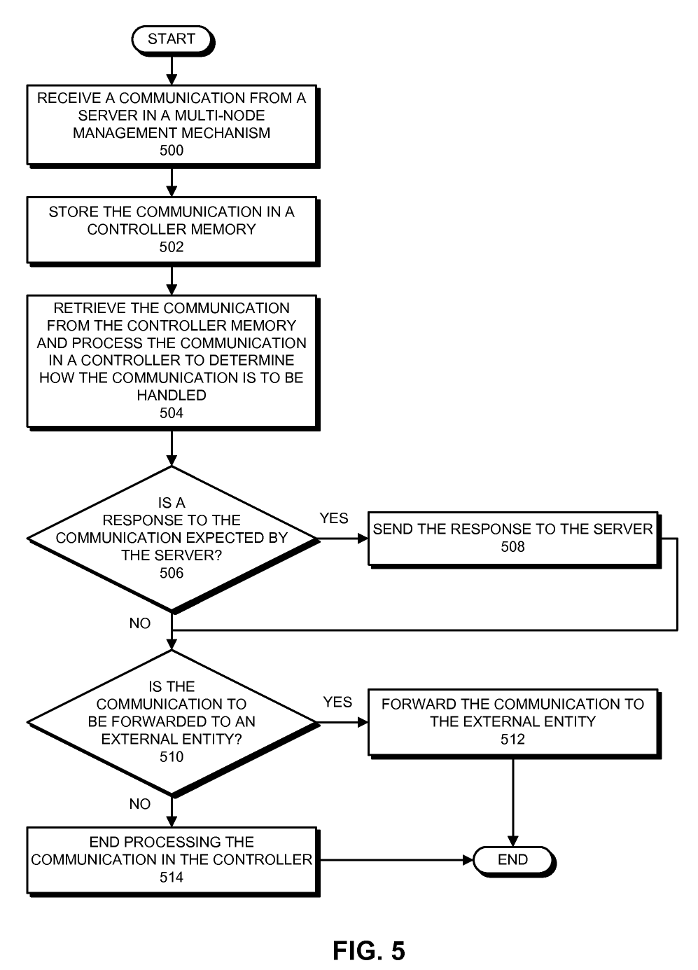

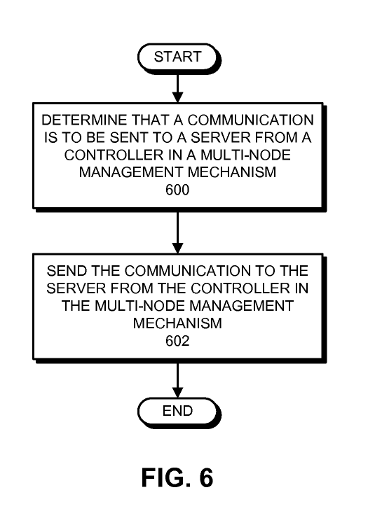

FIGS. 5 and 6 present flowchart illustrating aspects of managing multiple servers (“server nodes” or “nodes”) in accordance with some embodiments. More specifically, FIG. 5 presents a flowchart illustrating a process for handling communications from a server in accordance with some embodiments, and FIG. 6 presents a flowchart illustrating a process for communicating a command or request to a server in accordance with some embodiments. Although presented as separate figures, as described above, in some embodiments, multi-node management mechanism 112 performs operations for both processes. In addition, the operations shown in FIGS. 5 and/or 6 are presented as a general example of functions performed by some embodiments. The operations performed by other embodiments include different operations and/or operations that are performed in a different order. Additionally, although certain mechanisms are used in describing the process, in some embodiments, other mechanisms can perform the operations.

The process shown in FIG. 5 starts when multi-node management mechanism 112 receives a communication from a server (step 500). For example, in some embodiments, the communication comprises an indication of a BIOS error, a PCI link speed notification, etc. that is received on the LPC 404 bus from a server. As another example, in some embodiments, the communication comprises CPU status information and is received on the I2C/SMBus 402 bus from a server. As yet another example, in some embodiments, the communication comprises a presence signal received on the GPIO 400 bus from a server. More generally, any communication that may be transmitted from a server to multi-node management mechanism 112 on the LPC 404 bus, the I2C/SMBus 402, and/or the GPIO 400 bus can be received in multi-node management mechanism 112. In these embodiments, the communication can be in any format (packet, bit stream or pattern, etc.) used to transmit communications from a server to multi-node management mechanism 112 (i.e., that a server can generate and that multi-node management mechanism 112 can interpret).

Multi-node management mechanism 112 then stores the communication in controller memory 116 (step 502). In some embodiments, the communication is stored in a portion of controller memory 116 that is used for storing communications from the corresponding server. For example, in some embodiments, some or all of server 102-108 are each allocated a portion of controller memory 116 that is used for storing communications received from the corresponding server. However, in some embodiments, some or all of controller memory 116 is shared so that communications from one or more servers are stored in a same portion of controller memory 116.

Next, controller 114 retrieves the communication from controller memory 116 and processes the communication to determine how the communication is to be handled (step 504). In some embodiments, this operation comprises retrieving the communication along with zero or more other communications from the server from controller memory 116 and performing one or more computational operations such as communication rule lookups, table searches, filtering, format comparisons, content resolution, external entity lookups, etc. using the retrieved communication(s) to determine how the communication (and possibly the other communications) is to be handled. Note that, in some embodiments, operations 502 and 504 implement a “store and forward” memory in which controller 114 retrieves communication(s) that were first stored in controller memory 116.

If, during the processing of the communication, controller 114 determines that a response to the communication is expected by the server (step 506), controller 114 generates the response and sends the response to the server (step 508). For example, the communication from the server can be a heartbeat signal that is used by the server to ensure that multi-node management mechanism 112 is present and functioning, and controller 114 can respond appropriately. As another example, the server that sent the communication may expect an acknowledgement and controller 114 can send the acknowledgement to the server. As yet another example, the communication from the server may set a timer (e.g., a watchdog timer) in controller 114, and controller 114 can send a timer-end signal to the server (e.g., when the timer eventually expires). Generally, controller 114 can respond to any of various types of communication for which the server expects a response.

Otherwise, if controller 114 determines that no response to the communication is expected by the server (step 506), controller 114 determines if the communication is to be forwarded to an external entity (step 510). In some embodiments, the external entity is generally any entity that can receive the communication, e.g., a remote monitoring device (another computer system, a portable electronic device, etc.), a log event collecting system, etc. If the communication is to be forwarded to an external entity, controller 114 forwards the communication to the external entity (step 512). For example, if the external entity is a remote external server such as an external server on a LAN/WAN or on the Internet, controller 114 can generate one or more packets to be transmitted on network interface 128 (e.g., an Ethernet network interface) and can transmit the packets to the remote external server using network interface 128. As another example, if the external entity is a local external monitoring mechanism such as a diagnostic/configuration device coupled to multi-node management mechanism 112 using an RS-232 connection, controller 114 can generate one or more bit streams to be transmitted on UART 130 and can transmit the packets to the monitoring mechanism using UART 130.

If controller 114 determines that the communication is not to be forwarded to an external entity (step 510), controller 114 can end the processing of the communication (step 514).

The process shown in FIG. 6 starts when controller 114 determines that a communication is to be sent to a server from controller 114 (step 600). For example, controller 114 can determine that a server is to be power-cycled or reset and can assert the appropriate signal on the GPIO 400 bus. As another example, the server can determine that one or more communications are to be sent to a server on the I2C/SMBus 404 bus. Controller 114 then sends the communication to the server (step 602). In some embodiments, this comprises generating (creating, arranging/formatting, etc.) the communication and transmitting it to the server on the appropriate bus from busses 118. Note that, in some embodiments, the communications are one-to-one, in that controller 114 sends the communication on a particular bus for a particular server, and does not broadcast/multicast the signal.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An apparatus for managing a plurality of server nodes, comprising:
a multi-node management mechanism;
a separate set of busses coupled between each of the server nodes and the multi-node management mechanism; and
a controller in the multi-node management mechanism, the controller coupled to each bus in the sets of busses;
wherein the controller is configured to handle communications on each bus so that the multi-node management mechanism appears to a corresponding server node to be a separate endpoint for the bus.

2. The apparatus of claim 1, wherein each set of busses comprises:
a general purpose input-output (GPIO) bus;
an inter-integrated circuit (I2C) bus and/or system management bus (SMBus); and
a low pin count (LPC) bus.

3. The apparatus of claim 2, further comprising at least one processing mechanism in the controller, the processing mechanism executing, for each set of busses, a separate instance of a driver for each of the GPIO, I2C and/or SMBus, and LPC busses, each driver controlling operations for the corresponding bus in the set of busses.

4. The apparatus of claim 2, further comprising a server node communication mechanism in the controller, the server node communication mechanism responding to predetermined communications from the server nodes on at least one of the GPIO, I2C and/or SMBus, or LPC busses.

5. The apparatus of claim 1, further comprising a controller memory coupled to the controller, wherein at least some communications from the server nodes are stored in the controller memory.

6. The apparatus of claim 5, further comprising an external communication mechanism in the controller, the external communication mechanism forwarding selected communications from the controller memory to one or more external devices.

7. The apparatus of claim 1, further comprising, in the multi-node management mechanism:
a separate input-output port (JO port) coupled to each set of busses between a corresponding server node and the controller; and
transmit and receive circuits in each IO port for communicating between the corresponding server node and the controller on the busses in the corresponding set of busses.

8. The apparatus of claim 1, further comprising, in the multi-node management mechanism, an Ethernet network interface, wherein the controller is configured to communicate with an external device using the Ethernet network interface.

9. The apparatus of claim 1, further comprising, in the multi-node management mechanism, a Universal Asynchronous Receiver/Transmitter (UART), wherein the controller is configured to communicate with an external device using the UART.

10. A system for managing a plurality of server nodes, comprising:
a multi-node management mechanism;
a separate set of busses coupled between each of the server nodes and the multi-node management mechanism;
a controller in the multi-node management mechanism, the controller coupled to each bus in the sets of busses, wherein the controller is configured to handle communications on each bus so that the multi-node management mechanism appears to a corresponding server node to be a separate endpoint for the bus; and
a configuration memory coupled to the multi-node management mechanism, the configuration memory storing program code for at least one of configuring and operating the controller.

11. The system of claim 10, wherein each set of busses comprises:
a general purpose input-output (GPIO) bus;
an inter-integrated circuit (I2C) bus and/or system management bus (SMBus); and
a low pin count (LPC) bus.

12. The system of claim 11, further comprising, in each server node:
a central processing unit (CPU); and
a Southbridge controller hub coupled between the CPU and the set of busses coupled to the server node;
wherein the Southbridge controller hub handles communication for the CPU using the GPIO, I2C and/or SMBus, and LPC busses.

13. The system of claim 11, further comprising at least one processing mechanism in the controller, the processing mechanism executing, for each set of busses, a separate instance of a driver for each of the GPIO, I2C and/or SMBus, and LPC busses, each driver controlling operations for the corresponding bus in the set of busses.

14. The system of claim 11, further comprising a server node communication mechanism in the controller, the server node communication mechanism responding to predetermined communications from the server nodes on at least one of the GPIO, I2C and/or SMBus, or LPC busses.

15. The system of claim 10, further comprising a controller memory coupled to the controller, wherein at least some communications from the server nodes are stored in the controller memory.

16. The system of claim 15, further comprising an external communication mechanism in the controller, the external communication mechanism forwarding selected communications from the controller memory to one or more external devices.

17. The system of claim 10, further comprising, in the multi-node management mechanism:
a separate input-output port (JO port) coupled to each set of busses between a corresponding server node and the controller; and
transmit and receive circuits in each IO port for communicating between the corresponding server node and the controller on the busses in the corresponding set of busses.

18. The system of claim 10, further comprising a serial peripheral interface (SPI) bus coupled between the configuration memory and the controller in the multi-node management mechanism.

19. A method for managing a plurality of server nodes, comprising:
in a multi-node management mechanism, performing operations for:
receiving, on a bus from a set of busses coupled between the multi-node management mechanism and a server node, a communication from the server node;
storing the communication in a memory in the multi-node management mechanism; and
subsequently retrieving the stored communication from the memory and at least one of responding to the server node based on the communication or forwarding the communication to an external entity, wherein, in responding to the communication or forwarding the communication, the multi-node management mechanism appears to a corresponding server node to be a separate endpoint for the bus.

20. The method of claim 19, further comprising:
determining that a communication is to be sent to a server node, the communication causing the server node to perform a corresponding action; and
sending the communication to the server node.
